(19) United States
(12) Patent Application Publication
(10) Pub. No.: US 2026/0197859 A1
(43) Pub. Date: Jul. 9, 2026

(54) ENHANCED CHANNEL ACCESS USING CROSS-CELL ASSISTANCE

(71) Applicant: QUALCOMM Incorporated, San Diego, CA (US)

(72) Inventors: Kianoush HOSSEINI, San Diego, CA (US); Aria HASANZADEZONUZY, Chatham, NJ (US)

(21) Appl. No.: 19/380,719

(22) Filed: Nov. 5, 2025

Related U.S. Application Data
(60) Provisional application No. 63/743,170, filed on Jan. 8, 2025.

(51) Int. Cl. H04W 74/00; H04W 48/20

(52) U.S. Cl. CPC H04W 74/006; H04W 48/20

(57) ABSTRACT

Methods, systems, and devices for wireless communications are described. In some examples, a user equipment (UE) may receive information associated with performing access procedures on a target cell and one or more assisting cells. The UE may receive the information from the target cell or may receive portions of the information from both the target cell and the assisting cells. In some cases, the information may command the UE to perform the access procedure on the target cell, one or more assisting cells, or any combination thereof. In some other cases, the information may indicate for the UE to perform measurements to determine one or more cells for performing the access procedure. The UE may communicate access procedure messages with the selected cells. In some examples, the UE may split the messages up such that some or all of the messages are communicated across different cells.

### CROSS REFERENCES

The present Application for Patent claims the benefit of U.S. Provisional Patent Application No. 63/743,170 by HOSSEINI et al., entitled “ENHANCED CHANNEL ACCESS USING CROSS-CELL ASSISTANCE,” filed Jan. 8, 2025, which is assigned to the assignee hereof, and which is expressly incorporated by reference in its entirety herein.

### FIELD OF TECHNOLOGY

The following relates to wireless communications, including enhanced channel access using cross-cell assistance.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving, on a first cell, at least a portion of control information for communicating a set of multiple access procedure messages on the first cell, one or more additional cells, or both, selecting at least one cell from the first cell, the one or more additional cells, or both for communicating the set of multiple access procedure messages, and communicating the set of multiple access procedure messages on the first cell, the one or more additional cells, or both, based on the selecting.

A UE for wireless communications is described. The UE may include one or more memories storing processor executable code, and one or more processors coupled with the one or more memories. The one or more processors may individually or collectively be operable to execute the code to cause the UE to receive, on a first cell, at least a portion of control information for communicating a set of multiple access procedure messages on the first cell, one or more additional cells, or both, select at least one cell from the first cell, the one or more additional cells, or both for communicating the set of multiple access procedure messages, and communicate the set of multiple access procedure messages on the first cell, the one or more additional cells, or both, based on the selecting.

Another UE for wireless communications is described. The UE may include means for receiving, on a first cell, at least a portion of control information for communicating a set of multiple access procedure messages on the first cell, one or more additional cells, or both, means for selecting at least one cell from the first cell, the one or more additional cells, or both for communicating the set of multiple access procedure messages, and means for communicating the set of multiple access procedure messages on the first cell, the one or more additional cells, or both, based on the selecting.

A non-transitory computer-readable medium storing code for wireless communications is described. The code may include instructions executable by one or more processors to receive, on a first cell, at least a portion of control information for communicating a set of multiple access procedure messages on the first cell, one or more additional cells, or both, select at least one cell from the first cell, the one or more additional cells, or both for communicating the set of multiple access procedure messages, and communicate the set of multiple access procedure messages on the first cell, the one or more additional cells, or both, based on the selecting.

Some examples of the method, user equipment (UEs), and non-transitory computer-readable medium described herein may further include operations, features, means, or instructions for performing one or more measurements on the first cell, the one or more additional cells, or both based on the control information, where the UE selects the at least one cell based on the one or more measurements.

In some examples of the method, user equipment (UEs), and non-transitory computer-readable medium described herein, the UE selects the at least one cell based on the control information, the control information indicating for the UE to communicate the set of multiple access procedure messages over the at least one cell.

Some examples of the method, user equipment (UEs), and non-transitory computer-readable medium described herein may further include operations, features, means, or instructions for receiving a second portion of the control information on the first cell.

Some examples of the method, user equipment (UEs), and non-transitory computer-readable medium described herein may further include operations, features, means, or instructions for receiving at least a second portion of the control information on the one or more additional cells.

In some examples of the method, user equipment (UEs), and non-transitory computer-readable medium described herein, communicating the set of multiple access procedure messages may include operations, features, means, or instructions for transmitting a first access procedure message of the set of multiple access procedure messages on the one or more additional cells, where the UE transmits the first access procedure message via a first set of resource occasions (ROs) reserved for communications with the one or more additional cells, a first set of sequences reserved for communications with the one or more additional cells, or both.

In some examples of the method, user equipment (UEs), and non-transitory computer-readable medium described herein, communicating the set of multiple access procedure messages may include operations, features, means, or instructions for transmitting at least a portion of the set of multiple access procedure messages on the one or more additional cells, where the UE indicates the selected at least one cell via the portion of the set of multiple access procedure messages.

In some examples of the method, user equipment (UEs), and non-transitory computer-readable medium described herein, communicating the set of multiple access procedure messages may include operations, features, means, or instructions for receiving at least a second portion of the set of multiple access procedure messages on the selected at least one cell, where the selected at least one cell may be different from the one or more additional cells.

In some examples of the method, user equipment (UEs), and non-transitory computer-readable medium described herein, the UE transmits a set of multiple first access procedure messages on a respective set of multiple additional cells and the method, apparatuses, and non-transitory computer-readable medium may include further operations, features, means, or instructions for receiving a second access procedure message, where the second access procedure message indicates a second cell from the set of multiple additional cells that received at least one of the set of multiple first access procedure messages.

In some examples of the method, user equipment (UEs), and non-transitory computer-readable medium described herein, communicating the set of multiple access procedure messages may include operations, features, means, or instructions for transmitting a first instance of a first access procedure message of the set of multiple access procedure messages on at least one of the one or more additional cells and monitoring for a second access procedure message for an access procedure duration based on transmitting the first access procedure message.

In some examples of the method, user equipment (UEs), and non-transitory computer-readable medium described herein, communicating the set of multiple access procedure messages may include operations, features, means, or instructions for transmitting a second instance of the first access procedure message of the set of multiple access procedure messages on the at least one or more additional cells based on the monitoring, where the second instance of the first access procedure message may be associated with a higher transmission power than the first instance of the first access procedure message.

In some examples of the method, user equipment (UEs), and non-transitory computer-readable medium described herein, communicating the set of multiple access procedure messages may include operations, features, means, or instructions for selecting one or more second cells from the first cell and the one or more additional cells for communicating the set of multiple access procedure messages based on the monitoring and transmitting a second instance of the first access procedure message of the set of multiple access procedure messages on the one or more second cells.

In some examples of the method, user equipment (UEs), and non-transitory computer-readable medium described herein, the UE selects the one or more second cells based on monitoring a threshold quantity of access procedure durations.

In some examples of the method, user equipment (UEs), and non-transitory computer-readable medium described herein, communicating the set of multiple access procedure messages may include operations, features, means, or instructions for transmitting one or more first access procedure messages of the set of multiple access procedure messages on the first cell, monitoring for a second access procedure message for a quantity of access procedure durations based on transmitting the one or more first access procedure messages, selecting the one or more additional cells for communicating the set of multiple access procedure messages based on the monitoring, and transmitting the one or more first access procedure messages of the set of multiple access procedure messages on the one or more additional cells.

In some examples of the method, user equipment (UEs), and non-transitory computer-readable medium described herein, the UE selects the one or more second cells based on a capability of the UE, the capability including: a quantity associated with the one or more additional cells, an indication of whether an access procedure message can be transmitted on the first cell or the one or more additional cells, a quantity of repetitions associated with the first cell, the one or more additional cells, or both, an indication of whether repetitions of the set of multiple access procedure messages can be communicated via a set of multiple the one or more additional cells, band information associated with the one or more additional cells, or any combination thereof.

In some examples of the method, user equipment (UEs), and non-transitory computer-readable medium described herein, the control information may include operations, features, means, or instructions for one or more absolute radio-frequency channel numbers (ARFCN) associated with the first cell, the one or more additional cells, or both, an indication of a configuration for a synchronization signal block (SSB) associated with the first cell, the one or more additional cells, or both, a physical-layer cell identifier (PCID) associated with the first cell, the one or more additional cells, or both, selection criteria associated with the first cell, the one or more additional cells, or both, repetition information associated with the first cell, the one or more additional cells, or both, an indication of an association between an access procedure message and the first cell, the one or more additional cells, or both, system information block (SIB) acquisition information associated with the first cell, the one or more additional cells, or both, an indication of a configuration for an access procedure duration associated with the first cell, the one or more additional cells, or both, transmission power information associated with the first cell, the one or more additional cells, or both, or any combination thereof.

In some examples of the method, user equipment (UEs), and non-transitory computer-readable medium described herein, the control information may be received on the first cell, the one or more additional cells, or both based on whether the first cell may be a self-contained assisted cell.

In some examples of the method, user equipment (UEs), and non-transitory computer-readable medium described herein, the control information may be received on the first cell, the one or more additional cells, or both based on whether the UE selects the at least one cell based on a network command or selects the at least one cell based on performing measurements.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports enhanced channel access using cross-cell assistance in accordance with one or more aspects of the present disclosure.

FIG. 2 shows an example of a wireless communications system that supports enhanced channel access using cross-cell assistance in accordance with one or more aspects of the present disclosure.

FIG. 3 shows an example of a process flow that supports enhanced channel access using cross-cell assistance in accordance with one or more aspects of the present disclosure.

FIGS. 4 and 5 show block diagrams of devices that support enhanced channel access using cross-cell assistance in accordance with one or more aspects of the present disclosure.

FIG. 6 shows a block diagram of a communications manager that supports enhanced channel access using cross-cell assistance in accordance with one or more aspects of the present disclosure.

FIG. 7 shows a diagram of a system including a device that supports enhanced channel access using cross-cell assistance in accordance with one or more aspects of the present disclosure.

FIG. 8 shows a flowchart illustrating methods that support enhanced channel access using cross-cell assistance in accordance with one or more aspects of the present disclosure.

### DETAILED DESCRIPTION

In some wireless communications systems, devices may perform access procedures to establish communications with a network. For example, a user equipment (UE) may select one or more cells of a network entity and perform an access procedure (e.g., a random access channel (RACH) procedure) to establish communications with the network entity. In some examples, the network entity may configure one or more virtual cells for cell selection, which may leverage resources from multiple physical cells to perform RACH procedures more efficiently. For example, the UE may split messages of the access procedure across multiple cells for more efficient initial access. However, implementing virtual cells for initial access may introduce additional complexity. For example, the UE may only be capable of splitting access procedures across cells that are associated with the same virtual cell. In such examples, the network entity may define and maintain multiple virtual cell configurations both for initial access and when the UE 115-a is in a connected mode with the network entity.

Various aspects of the present disclosure are related to enhanced channel access using cross-cell assistance. In some examples, a UE may receive system information associated with performing an access procedure on a target cell as well as performing access procedures on one or more assisting cells. In some examples, the UE may receive all of the system information from the target cell. In some other examples, the UE may receive portions of the system information from the target cell and from some or all of the assisting cells. In some cases, the system information may command the UE to perform the access procedure on one or more selected cells, which may include the target cell, one or more assisting cells, or any combination thereof. In some other cases, the system information may indicate for the UE to perform measurements to determine the one or more selected cells for performing the access procedure. The UE may perform the access procedure by communicating one or more access procedure messages with the selected cells. In some examples, the UE may split the messages of the access procedure up such that some or all of the access procedure messages are communicated across different cells.

Aspects of the disclosure are initially described in the context of wireless communications systems. Aspects of the disclosure are additionally described with reference to process flows. Aspects of the disclosure are further illustrated by and described with reference to apparatus diagrams, system diagrams, and flowcharts that relate to enhanced channel access using cross-cell assistance.

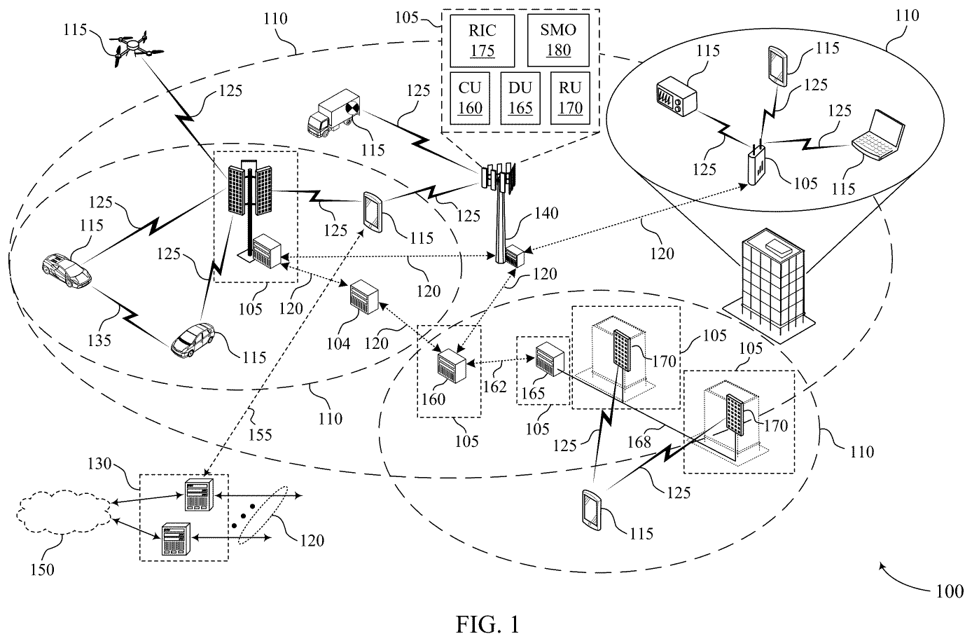

FIG. 1 shows an example of a wireless communications system 100 that supports enhanced channel access using cross-cell assistance in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3(L 3 ), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1(L 1 ) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support enhanced channel access using cross-cell assistance as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023). Each frame may include multiple consecutively-numbered subframes or

slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation. A subframe, a slot, a mini-slot, or a symbol may be the smallest scheduling

unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some examples, a UE 115 may receive system information associated with performing an access procedure (e.g., a RACH procedure) on a target cell as well as performing RACH procedures on one or more assisting cells for establishing communications with a network entity 105. In some examples, the UE 115 may receive all of the system information from the target cell. In some other examples, the UE 115 may receive portions of the system information from the target cell and from some or all of the assisting cells. In some cases, the system information may command the UE 115 to perform the access procedure on one or more selected cells, which may include the target cell, one or more assisting cells, or any combination thereof. In some other cases, the system information may indicate for the UE 115 to perform measurements to determine the one or more selected cells for performing the access procedure. The contents of the system information may be based on how the UE 115 receives the system information. For example, the UE 115 may receive different system information from just the target cell versus from each assisting cell.

The UE 115 may perform the access procedure by communicating one or more access procedure messages with the selected cells. In some examples, the UE 115 may split the messages of the access procedure up such that some or all of the access procedure messages are communicated across different cells. For example, the UE 115 may transmit a first portion of the access procedure messages on a first cell and may receive a second portion of the access procedure messages on a second cell. Additionally, or alternatively, the UE 115 may perform retransmissions of access procedure messages across different cells. For example, the UE 115 may transmit a first instance of a first access procedure message on a first cell. If the UE 115 fails to receive a response to the first access procedure message, the UE 115 may transmit a second instance of a first access procedure message on a second cell.

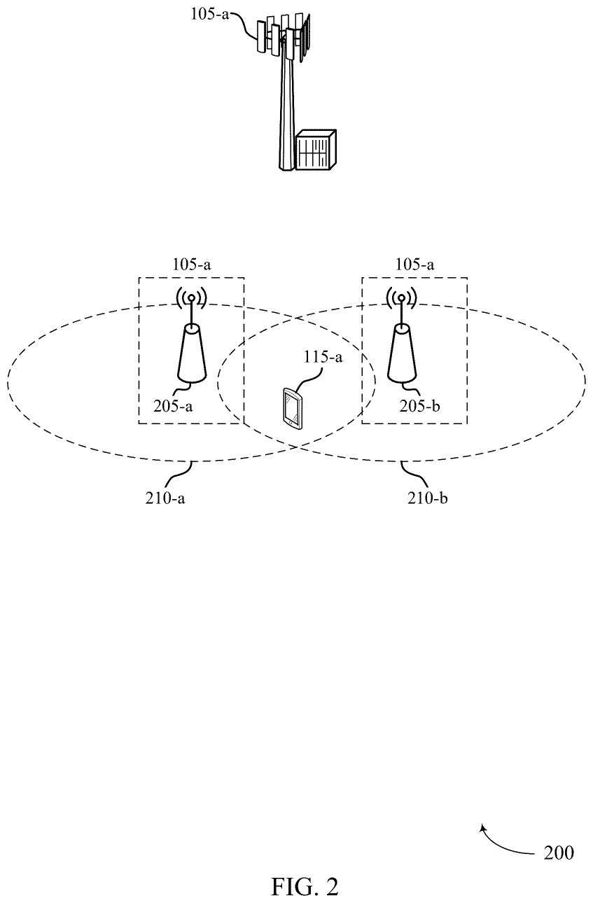

FIG. 2 shows an example of a wireless communications system 200 that supports enhanced channel access using cross-cell assistance in accordance with one or more aspects of the present disclosure. The wireless communications system 200 may include a UE 115-a in communications with a network entity 105-a, which may be examples of corresponding devices describes herein, including with reference to FIG. 1. The UE 115-a may communicate with the network entity 105-a via one or more access nodes 205 of the network entity 105-a. For example, the UE 115-a may communicate with a first access node 205-a, a second access node 205-b, or both, to communicate with the network entity 105-a. Each access node 205 may be associated with a cell 210 (e.g., a component carrier). For example, the first access node 205-a may be associated with a first cell 210-a, and the second access node 205-b may be associated with a second cell 210-b. In the example of FIG. 2, the first access node 205-a and the second access node 205-b may be co-located, and the first cell 210-a and the second cell 210-bmay overlap (e.g., partially, fully) in space.

To communicate with the network entity 105-a, the UE 115-a may perform an access procedure on one or more cells 210 and enter a connected mode (e.g., RRC connected). In some examples, the UE 115-a may select a cell 210 (e.g., the first cell 210-a) and perform a channel access procedure (e.g., a RACH procedure) to establish communications with the network entity 105-a. In some cases, the first cell 210-a, the second cell 210-b, or both, may be a virtual cell. A virtual cell may be configured with time resources, frequency resources, or both, across different cells 210 (e.g., physical cells 210), different component carriers, or different sub-bands (e.g., different portions of the frequency resources of a cell 210 or a component carrier) that are in a same frequency band or in different frequency bands. The network entity 105-a may indicate multiple virtual cells for cell selection.

In some cases, if a virtual cell is configured with resources across different bands (e.g., resources associated with a frequency-division duplex (FDD) cell 210 and resources associated with a time-division duplex (TDD) cell 210), channel access procedures may be performed more efficiently. For example, the UE 115-a may transmit a first message of an access procedure (e.g., a RACH Message 1 (Msg1)) and a third message of the access procedure (e.g., a RACH Message 3 (Msg3)) using a FDD cell 210 that is associated with improved uplink coverage. Similarly, the UE 115-a may receive a second message of the access procedure (e.g., a RACH Message 2 (Msg2)) and a fourth message of the access procedure (e.g., a RACH Message 4 (Msg4)) using a TDD cell 210 that is associated with increased downlink bandwidth availability. In such examples, the UE 115-a may split the access procedure (e.g., RACH procedure) across multiple cells 210 for more efficient initial access.

However, implementing virtual cells for initial access may introduce additional complexity. In a first example, the network entity 105-a may define and configure virtual cells. However, the network entity 105-a may use the virtual cell configuration as the initial configuration for communications with the UE 115-a when the UE 115-a is in the connected mode (e.g., RRC connected). In a second example, splitting an access procedure may be performed across cells 210 that are associated with the same virtual cell. In such examples, to allocate multiple FDD cells 210 for splitting an access procedure, the network entity 105-a may define multiple respective virtual cells, each virtual cell including at least one of the multiple FDD cells 210. Additionally, the network entity 105-a may maintain the same virtual cell configurations when the UE 115-a is in the connected mode.

Various aspects of the present disclosure are related to enhanced channel access using cross-cell assistance. In some examples, the UE 115-a may select a cell 210 (e.g., a target cell 210) for performing an access procedure to establish communications with the network entity 105-a. In some examples, the target cell 210 may be a cell 210 that the UE 115-a has chosen as a suitable cell 210 for performing the access procedure (e.g., after performing a cell selection procedure). For example, the UE 115-a may select the first cell 210-a for performing a RACH procedure. In some examples, the UE 115-a may use one or more assisting cells 210 (e.g., assisting cell(s) 210) to assist the UE 115-a in performing the RACH procedure on the first cell 210-a. For example, in FIG. 2, the UE 115- a may use the second cell 210-b to assist the UE 115-a in performing the RACH procedure on the first cell 210-a.

After the UE 115-a selects the first cell 210-a, the UE 115-a may acquire system information (e.g., a system information block (SIB)) including RACH assistance information. Such system information may enable the UE 115-a to perform the RACH procedure on the first cell 210-a. In some cases where the UE 115-a uses the second cell 210-b to assist the first cell 210-a, the first cell 210-a may provide a SIB to the UE 115-a. Such a SIB may include all information related to performing the RACH procedure on the target cell 210 (e.g., the first cell 210-a), as well as information related to performing the RACH procedure on the one or more assisting cells 210 (e.g., the second cell 210-b). In some other cases where the UE 115-a uses the second cell 210-bto assist the first cell 210-a, only a first portion of the system information may be provided to the UE 115-a via a SIB from the first cell 210-a. The first portion of the system information may include information related to performing the RACH procedure on the first cell 210-a. The UE 115-a may receive the remaining portions of the system information from the one or more assisting cells 210. For example, the UE 115-a may receive a second portion of the system information via a SIB from the second cell 210-b. In such examples, each assisting cell 210 may provide system information related to accessing the respective assisting cell 210 and, in some cases, may not include information related to accessing other assisting cells 210.

In some examples, the RACH assistance information from the network entity 105-a may directly command the UE 115-a to perform some or all of the steps of the RACH procedure on one cell 210 or on multiple cells 210. In such cases, the UE 115-amay perform the RACH procedure without performing additional measurements, comparisons, or evaluations. In such examples, the network entity 105-a may directly command the UE 115-a to balance network traffic loads for RACH procedures across multiple cells 210.

In some other examples, the RACH assistance information from the network entity 105-a may provide the UE 115-a with information for performing the RACH procedure on the target cell 210 (e.g., the first cell 210-a) and the one or more assisting cells 210 (e.g., the second cell 210-b). However, the UE 115-a may perform additional measurements, comparisons, or evaluation to select which of the target cell 210 (e.g., the first cell 210-a), the one or more assisting cells 210 (e.g., the second cell 210-b), or any combination thereof should be used for performing the RACH procedure. In such examples, in addition to balancing network traffic loads, performing additional measurements to select cells 210 for performing the RACH procedure may facilitate optimal cell selection for enhancing RACH coverage.

Each cell 210 (e.g., the target cell 210, the one or more assisting cells 210) may provide RACH configuration information about the cell 210, one or more other cells 210, or any combination thereof. In some examples, such RACH configuration information may include an absolute radio-frequency channel number (ARFCN), a synchronization signal block (SSB) configuration, a physical-layer cell identifier (PCID), cell selection criteria, repetition information, an indication of an association between a cell 210 and an access procedure message, SIB acquisition information, a random access response (RAR) window configuration, power transmission information, or any combination thereof.

Cell selection criteria may include one or more thresholds for comparing measurements, one or more offsets for comparing measurements, or any combination thereof. For example, the cell selection criteria may include one or more factors used in prioritization of certain cells 210 for performing some or all of the RACH procedure. As an example, the UE 115-a may be configured to transmit up to 8 repetitions of a random access message (e.g., RACH Msg1, RACH Msg3, or both). If the target cell 210 (e.g., the first cell 210-a) is associated with a threshold quantity of allowed repetitions that is less than 8, the UE 115-a may select an assisting cell 210 (e.g., the second cell 210-b) for transmitting the random access message.

In some cases, the RACH configuration information may indicate an association between a cell 210 and an access procedure message. For example, the RACH configuration information may indicate that one or more messages of the access procedure (e.g., RACH Msg1, RACH Msg3, or both) are associated with one assisting cell 210 (e.g., the second cell 210-b) or a first set of assisting cells 210. Similarly, the RACH configuration information may indicate that another one or more messages of the access procedure (e.g., RACH Msg2, RACH Msg4, or both) are associated with the target cell 210 (e.g., the first cell 210-a) or a second set of assisting cells 210. Additionally, or alternatively, the RACH configuration information may indicate a cell 210 for transmission of a physical uplink control channel (PUCCH) in response to receiving a RACH Msg4, may indicate which cells 210 should be used for transmitting repetitions of the PUCCH, or any combination thereof.

In some cases, the RACH configuration information may include SIB acquisition information. For example, the RACH configuration information may include an initial control resource set (CORESET) configuration for decoding a physical downlink control channel (PDCCH) that schedules a SIB. Additionally, or alternatively, the RACH configuration information may include a configuration for requesting SIB from other assisting cells 210.

In some cases, the RACH configuration information may include power transmission information. For example, the RACH configuration information may include information about how to adjust (e.g., ramp up, increase) power for transmission of an access procedure message (e.g., RACH Msg1) on the cell 210.

In some examples, the specific information included in the RACH configuration information and the cells 210 that provide the RACH configuration information may be based on how the UE 115-a is configured to receive the RACH configuration information. Alternatively, in some other examples where cell selection is flexible or configurable (e.g., dynamically configurable), the specific information may be indicated to the UE 115-a. For example, if the UE 115-a is configured to perform measurements to select one or more cells 210 for performing an access procedure, the target cell 210 (e.g., the first cell 210-a) may provide the UE 115-a with information about finding other cells 210, such as an ARFCN, a SSB configuration, as well as one or more criteria for selecting the one or more cells 210 for performing the access procedure.

After the UE 115-a selects a cell 210 (e.g., the target cell 210, one or more assisting cells 210), the remaining RACH configuration information may be provided to the UE 115-a via a SIB of the selected cell 210 or from both a physical broadcast channel (PBCH) and the SIB of the selected cell 210. In some cases where the information is only provided in the SIB of the selected cell 210, the target cell 210 (e.g., the first cell 210-a) may also provide the UE 115-a with information about acquiring the SIB for the one or more assisting cells 210, such as an initial CORESET configuration associated with the one or more assisting cells 210. In some other cases where the information is provided in both the PBCH and the SIB of each assisting cell 210, each SIB from each assisting cell may include less information (e.g., may be lighter).

In some examples, after the UE 115-a acquires the RACH configuration information, the UE 115-a may perform SSB measurements on the target cell 210 (e.g., the first cell 210-a) and the one or more assisting cells 210 indicated by the RACH configuration information (e.g., the second cell 210-b ). For example, the UE may determine one or more metrics (e.g., a reference signal received power (RSRP)) associated with the first cell 210-a and the second cell 210-b. Using the measurements and based on selection criteria provided to the UE 115-a (e.g., included in the RACH configuration information), the UE 115-a may select a cell 210. For example, the UE 115-a may compare an RSRP of a first SSB received on the target cell 210 (e.g., the first cell 210-a) and a second SSB received on one assisting cell 210 (e.g., the second cell 210-b). If the RSRP difference, a weighted difference based on a prioritization factor, or any other function between the first SSB and the second SSB satisfies (e.g., is above, is below) a threshold, the UE 115-a may select one of the target cell 210 (e.g., the first cell 210-a) or the one assisting cell 210 (e.g., the second cell 210-b).

Cell selection may be performed per message of the access procedure, per group of messages (e.g., RACH Msg1 and RACH Msg3 are transmitted on a same cell 210), per repetition of a message (each repetition or set of repetitions of a RACH Msg1 may be transmitted on different cells 210), or any combination thereof. In some examples, the metrics (e.g., criteria) for comparison, the prioritization factor, and any threshold or offset values associated with cell selection may be shared for all messages of the access procedure or may be set separately for each message of the access procedure. For example, the UE 115-a may be configured with different criteria for selecting a robust uplink cell for transmitting a RACH Msg1 versus transmitting a RACH Msg3. In some cases, the UE 115-a may select an assisting cell 210 (e.g., the second cell 210-b) for communicating some (e.g., a subset) or all of the access procedure messages.

It may be beneficial to distinguish between instances where the UE 115-a accesses an assisting cell 210 (e.g., the second cell 210-b) directly and instances where the UE 115-a access the assisting cell 210 to connect to the target cell 210 (e.g., the first cell 210-a). In some examples, the UE 115-a may implement resource partitioning (e.g., RACH partitioning) to implicitly indicate which type of access the UE 115-a is performing. For example, the resource occasions (ROs) and sequences for transmitting the access procedure message may be separated into multiple sets, where a first set is used for direct access to an assisting cell 210 and where a second set is used when the UE 115-a uses the assisting cell 210 to connect to the target cell 210. If the UE 115-a is configured to transmit an access procedure message (e.g., a RACH Msg1) to an assisting cell 210 (e.g., the second cell 210-b), the UE 115-a may select a RO, sequence, or both from either the first or second set of ROs and sequences for transmitting the access procedure message.

In some other examples, the UE 115-a may explicitly indicate whether the UE 115-a is accessing the assisting cell 210 to connect to the target cell 210. For example, the UE 115-a may communicate a first portion of the access procedure messages (e.g., RACH Msg1, Msg2, and Msg3) with the assisting cell 210. One of the messages included in the first portion of the access procedure messages (e.g., the RACH Msg3) may indicate, to the assisting cell 210, information about the cell 210 (e.g., the target cell 210) the UE 115-a is trying to connect to. In some cases, with additional information (e.g., SIB on the target cell 210), the UE 115-a may receive a second (e.g., remaining) portion of the access procedure messages (e.g., RACH Msg4) on a different cell 210 from the assisting cell 210, such as the target cell 210.

Additionally, or alternatively, there may be cases where the UE 115-a transmits multiple instances of an access procedure message on different cells 210. For example, the UE 115-a may transmit repetitions of a RACH Msg1 in frequency on multiple cells 210. In such cases, the UE 115-a may receive one or more responses to the access procedure message (e.g., a RACH Msg2). Each response may provide the UE 115-a with a RO index, a sequence index, or both, as well as an indication of which cell 210 received the RACH Msg1.

In some examples, the techniques for enhanced channel access using cross-cell assistance may be based on UE capability (e.g., a capability of the UE 115-a). For example, if the UE 115-a does not support splitting an access procedure across multiple cells 210 (e.g., the UE 115-a cannot perform measurement comparison across the target cell 210 and all assisting cells 210), the UE 115-a may disregard some or all of the RACH configuration information. For example, the UE 115-a may perform the access procedure only with the target cell or may evaluate a portion of the assisting cells 210. The UE capability may be defined by (e.g., may include) a quantity of assisting cells 210, an indication of which access procedure messages may be communicated on which cell 210, a quantity of access procedure message repetitions associated with each assisting cell 210, whether the UE supports transmitting access procedure message repetitions across multiple assisting cells 210, bands associated with each assisting cell 210, or any combination thereof. In some cases where the UE capability includes bands associated with the assisting cells 210, the UE capability may be reported as a function of a band combination (e.g., the band of the target cell 210 and the bands of each assisting cell 210). Additionally, or alternatively, the UE capability may distinguish between different band types (e.g., TDD bands, FDD bands, sub-band full-duplex (SBFD) bands), different frequency ranges, or both.

In some cases, after transmitting a first access procedure message (e.g., a RACH Msg1) to an assisting cell 210, the UE 115-a may monitor for a response (e.g., a RACH Msg2) within a duration (e.g., a RAR window). In such cases, if the UE 115-a does not receive the response within the RAR window, the UE 115-a may retransmit the first access procedure message (e.g., with a higher transmission power). Additionally, or alternatively, the UE 115-a may select another assisting cell 210 or multiple additional assisting cells 210 for transmitting the first access procedure message. Cell ordering for selecting such assisting cells may be performed when the UE 115-a is performing measurements and evaluating the assisting cells 210. In some examples, the UE 115-a may monitor for the response up to a threshold quantity of RAR windows and transmit a retransmission of the first access procedure message for each RAR window. After the UE 115-a satisfies the threshold quantity of RAR windows, the UE 115-a may select another assisting cell 210. The threshold quantity of RAR windows may be provided to the UE 115-a via the SIB of the target cell 210.

Similarly, the UE 115-a may initiate splitting an access procedure over multiple cells 210 conditionally based on monitoring for a response over one or more RAR windows. For example, the UE 115-a may attempt to access the target cell 210 by transmitting a first access procedure message (e.g., a RACH Msg1). If the UE 115-a does not receive a response to the first access procedure message (e.g., a RACH Msg2) within one RAR window or within a threshold quantity of RAR windows, the UE 115-a may determine to split the access procedure across one or more assisting cells 210. The threshold quantity of RAR windows may be provided to the UE 115-a via the SIB of the target cell 210.

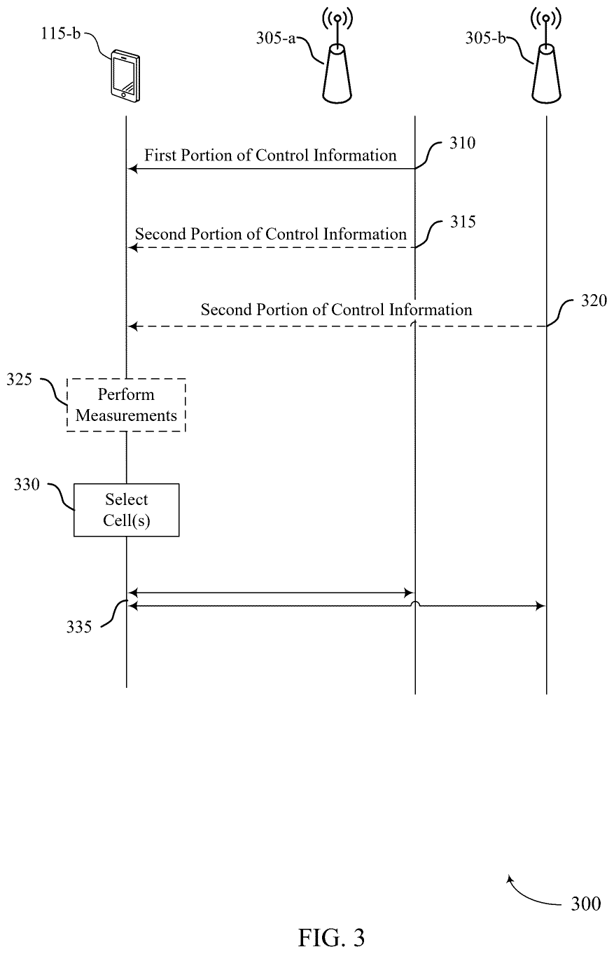

FIG. 3 shows an example of a process flow 300 that supports enhanced channel access using cross-cell assistance in accordance with one or more aspects of the present disclosure. The process flow 300 may implement or be implemented by aspects of the wireless communications system 100 and the wireless communications system 200 as described herein with reference to FIGS. 1 and 2. For example, the process flow 300 may illustrate actions performed by a UE 115-b, a first cell 305-a, and one or more additional cells 305-b, which may be an example of corresponding devices described herein, including with reference to FIGS. 1 and 2. In the following description of the process flow 300, the operations between the UE 115-b, the first cell 305-a, and the one or more additional cells 305-b may be performed in a different order than the example shown, or the operations between the UE 115-b, the first cell 305-a, and the one or more additional cells 305-b may be performed in different orders at different times. Some operations may also be omitted from the process flow 300, and other operations may be added to the process flow 300.

At 310, the UE 115-b may receive, on a first cell 305-a, at least a portion of control information for communicating a plurality of access procedure messages on the first cell 305-a, the one or more additional cells 305-b, or both. In some examples, at 315, the UE 115-b may receive a second portion of the control information on the first cell 305-a. In some other examples, at 320, the UE 115-b may receive at least the second portion of the control information on the one or more additional cells 305-b.

At 325, the UE 115-b may perform one or more measurements on the first cell 305-a, the one or more additional cells 305-b, or both based on the control information. In such cases, the UE 115-b may select at least one cell from the first cell 305-a, the one or more additional cells 305-b, or both for communicating the plurality of access procedure messages.

At 330, the UE 115-b may select the at least one cell from the first cell 305-a, the one or more additional cells 305-b, or both for communicating the plurality of access procedure messages. In some examples, selecting the at least one cell may be based on the one or more measurements. Additionally, or alternatively, the UE 115-b may select the at least one cell based on the control information, the control information indicating for the UE 115-b to communicate the plurality of access procedure messages over the at least one cell.

At 335, the UE 115-b may communicate the plurality of access procedure messages on the first cell 305-a, the one or more additional cells 305-b, or both, based on the selecting.

In one example, to communicate the plurality of access procedure messages, the UE 115-b may transmit a first access procedure message of the plurality of access procedure messages on the one or more additional cells 305-b. In such examples, the UE 115-b may transmit the first access procedure message via a first set of resource occasions reserved for communications with the one or more additional cells 305-b, a first set of sequences reserved for communications with the one or more additional cells 305-b, or both.

In another example, the UE 115-b may transmit a plurality of first access procedure messages on a respective plurality of additional cells 305-b. In such examples, the UE 115-b may receive a second access procedure message, where the second access procedure message indicates a second cell from the plurality of additional cells 305-b that received at least one of the plurality of first access procedure messages.

In yet another example, to communicate the plurality of access procedure messages, the UE 115-b may transmit at least a portion of the plurality of access procedure messages on the one or more additional cells 305-b. In such examples, the UE 115-b may indicate the selected at least one cell via the portion of the plurality of access procedure messages. In response to transmitting the portion of the plurality of access procedure messages on the one or more additional cells 305-b, the UE 115-b may receive at least a second portion of the plurality of access procedure messages on the selected at least one cell (e.g., the first cell 305-a), wherein the selected at least one cell is different from the one or more additional cells 305-b.

For example, the UE 115-b may transmit a first instance of a first access procedure message of the plurality of access procedure messages on at least one of the one or more additional cells 305-b. The UE 115-b may monitor for a second access procedure message for an access procedure duration based on transmitting the first access procedure message. In some cases, the UE 115-b may transmit a second instance of the first access procedure message of the plurality of access procedure messages on the at least one or more additional cells 305-b based on the monitoring (e.g., if the UE 115-b does not receive the second access procedure message within the access procedure duration). In such cases, the second instance of the first access procedure message may be associated with a higher transmission power than the first instance of the first access procedure message.

Additionally, or alternatively, the UE 115-b may select one or more second cells from the first cell 305-a and the one or more additional cells 305-b for communicating the plurality of access procedure messages based on the monitoring. The UE 115-b may select the one or more second cells based on monitoring a threshold quantity of access procedure durations. After selecting the one or more second cells, the UE 115-b may transmit a second instance of the first access procedure message of the plurality of access procedure messages on the one or more second cells.

In another example, the UE 115-b may transmit one or more first access procedure messages of the plurality of access procedure messages on the first cell 305-a. The UE 115-b may monitor for a second access procedure message for a quantity of access procedure durations based on transmitting the one or more first access procedure messages. In some cases, the UE 115-b may select the one or more additional cells 305-b for communicating the plurality of access procedure messages based on the monitoring. For example, the UE 115-b may select the one or more additional cells 305-b if the UE 115-b fails to receive the second access procedure message within the quantity of access procedure durations. The UE 115-b may transmit the one or more first access procedure messages of the plurality of access procedure messages on the one or more additional cells 305-b.

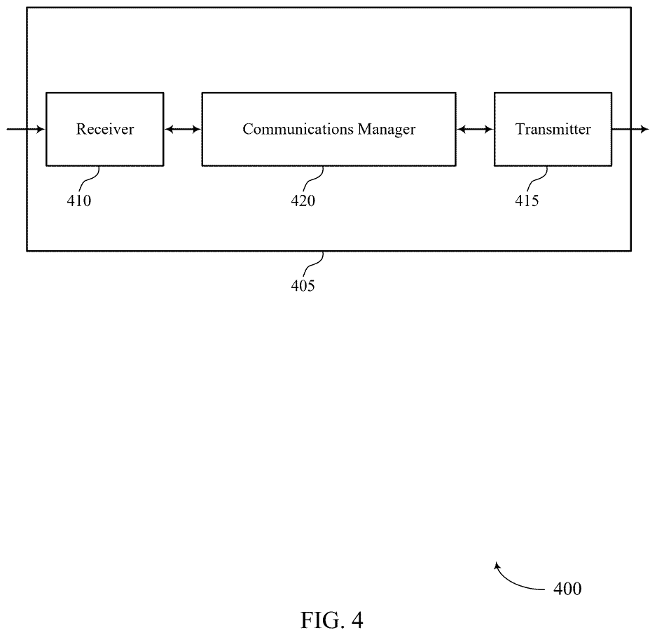

FIG. 4 shows a block diagram 400 of a device 405 that supports enhanced channel access using cross-cell assistance in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to enhanced channel access using cross-cell assistance). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to enhanced channel access using cross-cell assistance). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of enhanced channel access using cross-cell assistance as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving, on a first cell, at least a portion of control information for communicating a set of multiple access procedure messages on the first cell, one or more additional cells, or both. The communications manager 420 is capable of, configured to, or operable to support a means for selecting at least one cell from the first cell, the one or more additional cells, or both for communicating the set of multiple access procedure messages. The communications manager 420 is capable of, configured to, or operable to support a means for communicating the set of multiple access procedure messages on the first cell, the one or more additional cells, or both, based on the selecting.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for reduced processing and more efficient utilization of communication resources.

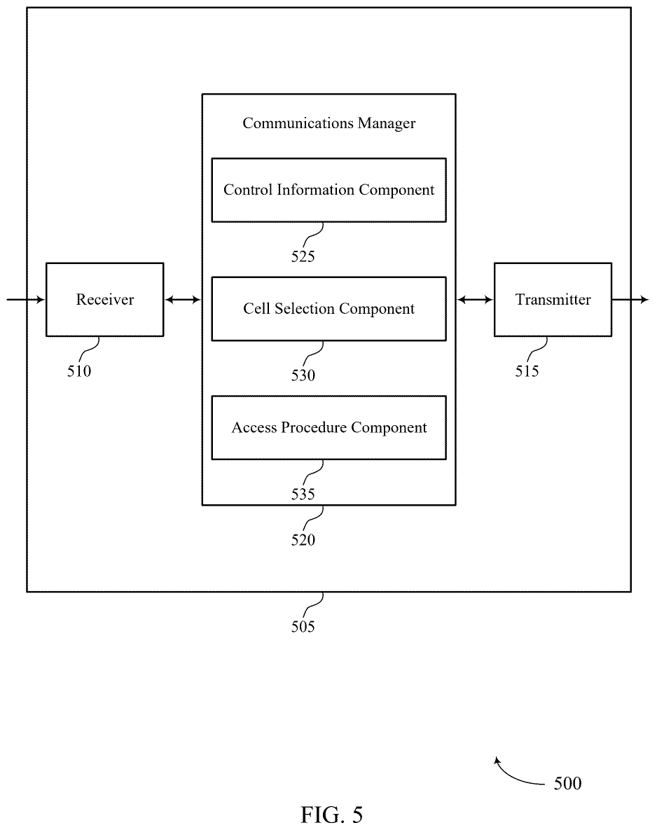

FIG. 5 shows a block diagram 500 of a device 505 that supports enhanced channel access using cross-cell assistance in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to enhanced channel access using cross-cell assistance). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to enhanced channel access using cross-cell assistance). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of enhanced channel access using cross-cell assistance as described herein. For example, the communications manager 520 may include a control information component 525, a cell selection component 530, an access procedure component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The control information component 525 is capable of, configured to, or operable to support a means for receiving, on a first cell, at least a portion of control information for communicating a set of multiple access procedure messages on the first cell, one or more additional cells, or both. The cell selection component 530 is capable of, configured to, or operable to support a means for selecting at least one cell from the first cell, the one or more additional cells, or both for communicating the set of multiple access procedure messages. The access procedure component 535 is capable of, configured to, or operable to support a means for communicating the set of multiple access procedure messages on the first cell, the one or more additional cells, or both, based on the selecting.

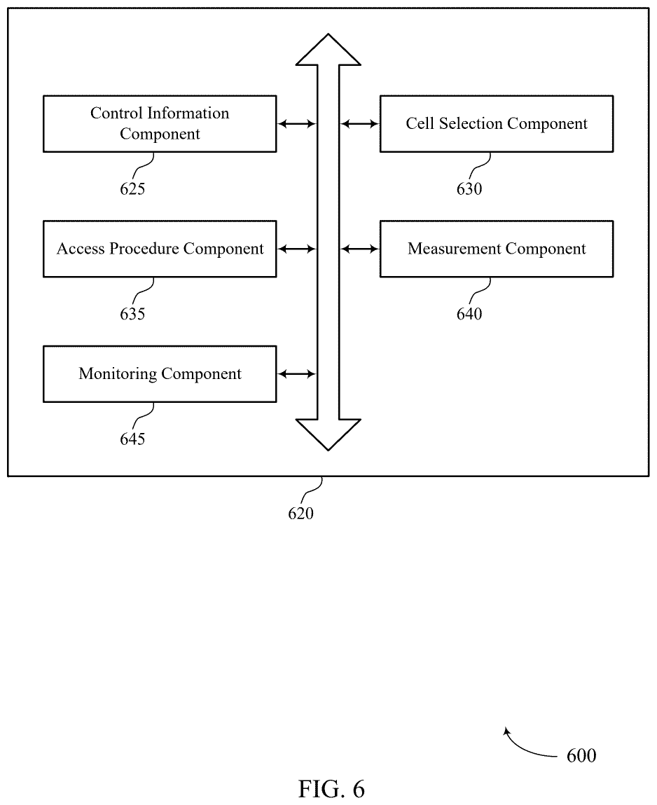

FIG. 6 shows a block diagram 600 of a communications manager 620 that supports enhanced channel access using cross-cell assistance in accordance with one or more aspects of the present disclosure. The communications manager 620 may be an example of aspects of a communications manager 420, a communications manager 520, or both, as described herein. The communications manager 620, or various components thereof, may be an example of means for performing various aspects of enhanced channel access using cross-cell assistance as described herein. For example, the communications manager 620 may include a control information component 625, a cell selection component 630, an access procedure component 635, a measurement component 640, a monitoring component 645, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The control information component 625 is capable of, configured to, or operable to support a means for receiving, on a first cell, at least a portion of control information for communicating a set of multiple access procedure messages on the first cell, one or more additional cells, or both. The cell selection component 630 is capable of, configured to, or operable to support a means for selecting at least one cell from the first cell, the one or more additional cells, or both for communicating the set of multiple access procedure messages. The access procedure component 635 is capable of, configured to, or operable to support a means for communicating the set of multiple access procedure messages on the first cell, the one or more additional cells, or both, based on the selecting.

In some examples, the measurement component 640 is capable of, configured to, or operable to support a means for performing one or more measurements on the first cell, the one or more additional cells, or both based on the control information, where the UE selects the at least one cell based on the one or more measurements.

In some examples, the UE selects the at least one cell based on the control information, the control information indicating for the UE to communicate the set of multiple access procedure messages over the at least one cell.

In some examples, the control information component 625 is capable of, configured to, or operable to support a means for receiving a second portion of the control information on the first cell.

In some examples, the control information component 625 is capable of, configured to, or operable to support a means for receiving at least a second portion of the control information on the one or more additional cells.

In some examples, to support communicating the set of multiple access procedure messages, the access procedure component 635 is capable of, configured to, or operable to support a means for transmitting a first access procedure message of the set of multiple access procedure messages on the one or more additional cells, where the UE transmits the first access procedure message via a first set of resource occasions reserved for communications with the one or more additional cells, a first set of sequences reserved for communications with the one or more additional cells, or both.

In some examples, to support communicating the set of multiple access procedure messages, the access procedure component 635 is capable of, configured to, or operable to support a means for transmitting at least a portion of the set of multiple access procedure messages on the one or more additional cells, where the UE indicates the selected at least one cell via the portion of the set of multiple access procedure messages.

In some examples, to support communicating the set of multiple access procedure messages, the access procedure component 635 is capable of, configured to, or operable to support a means for receiving at least a second portion of the set of multiple access procedure messages on the selected at least one cell, where the selected at least one cell is different from the one or more additional cells.

In some examples, the UE transmits a set of multiple first access procedure messages on a respective set of multiple additional cells, and the access procedure component 635 is capable of, configured to, or operable to support a means for receiving a second access procedure message, where the second access procedure message indicates a second cell from the set of multiple additional cells that received at least one of the set of multiple first access procedure messages.

In some examples, to support communicating the set of multiple access procedure messages, the access procedure component 635 is capable of, configured to, or operable to support a means for transmitting a first instance of a first access procedure message of the set of multiple access procedure messages on at least one of the one or more additional cells. In some examples, to support communicating the set of multiple access procedure messages, the monitoring component 645 is capable of, configured to, or operable to support a means for monitoring for a second access procedure message for an access procedure duration based on transmitting the first access procedure message.

In some examples, to support communicating the set of multiple access procedure messages, the access procedure component 635 is capable of, configured to, or operable to support a means for transmitting a second instance of the first access procedure message of the set of multiple access procedure messages on the at least one or more additional cells based on the monitoring, where the second instance of the first access procedure message is associated with a higher transmission power than the first instance of the first access procedure message.

In some examples, to support communicating the set of multiple access procedure messages, the cell selection component 630 is capable of, configured to, or operable to support a means for selecting one or more second cells from the first cell and the one or more additional cells for communicating the set of multiple access procedure messages based on the monitoring. In some examples, to support communicating the set of multiple access procedure messages, the access procedure component 635 is capable of, configured to, or operable to support a means for transmitting a second instance of the first access procedure message of the set of multiple access procedure messages on the one or more second cells.

In some examples, the UE selects the one or more second cells based on monitoring a threshold quantity of access procedure durations.

In some examples, to support communicating the set of multiple access procedure messages, the access procedure component 635 is capable of, configured to, or operable to support a means for transmitting one or more first access procedure messages of the set of multiple access procedure messages on the first cell. In some examples, to support communicating the set of multiple access procedure messages, the monitoring component 645 is capable of, configured to, or operable to support a means for monitoring for a second access procedure message for a quantity of access procedure durations based on transmitting the one or more first access procedure messages. In some examples, to support communicating the set of multiple access procedure messages, the cell selection component 630 is capable of, configured to, or operable to support a means for selecting the one or more additional cells for communicating the set of multiple access procedure messages based on the monitoring. In some examples, to support communicating the set of multiple access procedure messages, the access procedure component 635 is capable of, configured to, or operable to support a means for transmitting the one or more first access procedure messages of the set of multiple access procedure messages on the one or more additional cells.

In some examples, the UE selects the at least one cell based on a capability of the UE, the capability including: a quantity associated with the one or more additional cells, an indication of whether an access procedure message can be transmitted on the first cell or the one or more additional cells, a quantity of repetitions associated with the first cell, the one or more additional cells, or both, an indication of whether repetitions of the set of multiple access procedure messages can be communicated via a set of multiple the one or more additional cells, band information associated with the one or more additional cells, or any combination thereof.

In some examples, the control information includes: one or more absolute radio-frequency channel numbers associated with the first cell, the one or more additional cells, or both, an indication of a configuration for a synchronization signal block associated with the first cell, the one or more additional cells, or both, a physical-layer cell identifier associated with the first cell, the one or more additional cells, or both, selection criteria associated with the first cell, the one or more additional cells, or both, repetition information associated with the first cell, the one or more additional cells, or both, an indication of an association between an access procedure message and the first cell, the one or more additional cells, or both, system information block acquisition information associated with the first cell, the one or more additional cells, or both, an indication of a configuration for an access procedure duration associated with the first cell, the one or more additional cells, or both, transmission power information associated with the first cell, the one or more additional cells, or both, or any combination thereof.

In some examples, the control information is received on the first cell, the one or more additional cells, or both based on whether the first cell is a self-contained assisted cell.

In some examples, the control information is received on the first cell, the one or more additional cells, or both based on whether the UE selects the at least one cell based on a network command or selects the at least one cell based on performing measurements.

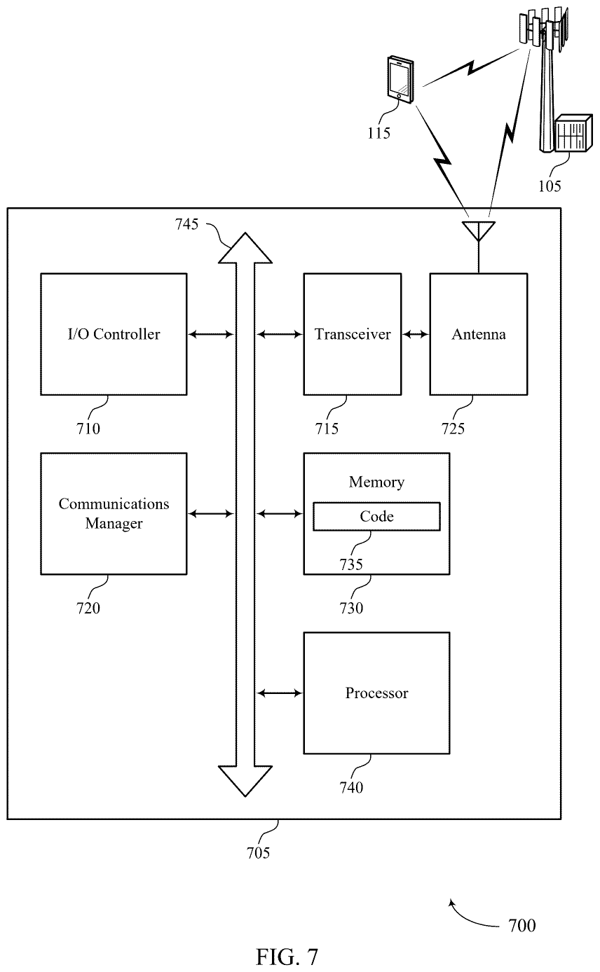

FIG. 7 shows a diagram of a system 700 including a device 705 that supports enhanced channel access using cross-cell assistance in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting enhanced channel access using cross-cell assistance). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for receiving, on a first cell, at least a portion of control information for communicating a set of multiple access procedure messages on the first cell, one or more additional cells, or both. The communications manager 720 is capable of, configured to, or operable to support a means for selecting at least one cell from the first cell, the one or more additional cells, or both for communicating the set of multiple access procedure messages. The communications manager 720 is capable of, configured to, or operable to support a means for communicating the set of multiple access procedure messages on the first cell, the one or more additional cells, or both, based on the selecting.

By including or configuring the communications manager 720 in accordance with examples as described herein, the device 705 may support techniques for reduced latency and improved user experience related to reduced processing, more efficient utilization of communication resources, and improved coordination between devices.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of enhanced channel access using cross-cell assistance as described herein, or the at least one processor 740 and the at least one memory 730 may be otherwise configured to, individually or collectively, perform or support such operations.

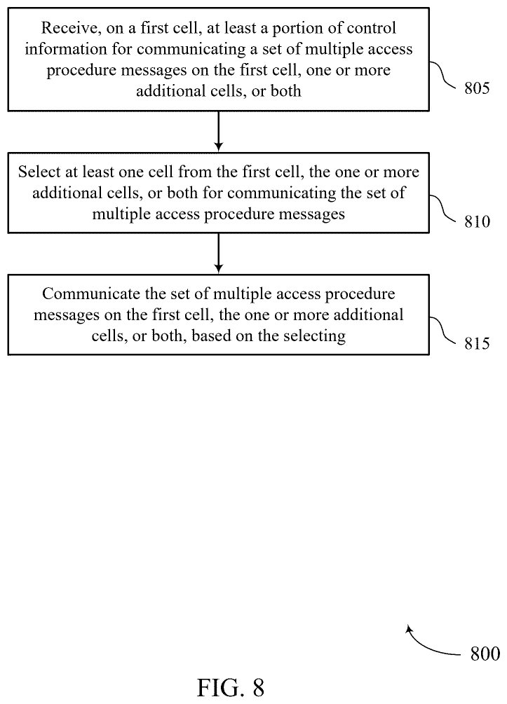

FIG. 8 shows a flowchart illustrating a method 800 that supports enhanced channel access using cross-cell assistance in accordance with one or more aspects of the present disclosure. The operations of the method 800 may be implemented by a UE or its components as described herein. For example, the operations of the method 800 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 805, the method may include receiving, on a first cell, at least a portion of control information for communicating a set of multiple access procedure messages on the first cell, one or more additional cells, or both. The operations of 805 may be performed in accordance with examples as disclosed herein. In some examples, aspects of the operations of 805 may be performed by a control information component 625 as described with reference to FIG. 6.

At 810, the method may include selecting at least one cell from the first cell, the one or more additional cells, or both for communicating the set of multiple access procedure messages. The operations of 810 may be performed in accordance with examples as disclosed herein. In some examples, aspects of the operations of 810 may be performed by a cell selection component 630 as described with reference to FIG. 6.

At 815, the method may include communicating the set of multiple access procedure messages on the first cell, the one or more additional cells, or both, based on the selecting. The operations of 815 may be performed in accordance with examples as disclosed herein. In some examples, aspects of the operations of 815 may be performed by an access procedure component 635 as described with reference to FIG. 6.

The following provides an overview of aspects of the present disclosure:

Aspect 1: A method for wireless communications at a UE, comprising: receiving, on a first cell, at least a portion of control information for communicating a plurality of access procedure messages on the first cell, one or more additional cells, or both; selecting at least one cell from the first cell, the one or more additional cells, or both for communicating the plurality of access procedure messages; and communicating the plurality of access procedure messages on the first cell, the one or more additional cells, or both, based at least in part on the selecting.

Aspect 2: The method of aspect 1, further comprising: performing one or more measurements on the first cell, the one or more additional cells, or both based at least in part on the control information, wherein the UE selects the at least one cell based at least in part on the one or more measurements.

Aspect 3: The method of any of aspects 1 through 2, wherein the UE selects the at least one cell based at least in part on the control information, the control information indicating for the UE to communicate the plurality of access procedure messages over the at least one cell.

Aspect 4: The method of any of aspects 1 through 3, further comprising: receiving a second portion of the control information on the first cell.

Aspect 5: The method of any of aspects 1 through 3, further comprising: receiving at least a second portion of the control information on the one or more additional cells.

Aspect 6: The method of any of aspects 1 through 5, wherein communicating the plurality of access procedure messages further comprises: transmitting a first access procedure message of the plurality of access procedure messages on the one or more additional cells, wherein the UE transmits the first access procedure message via a first set of ROs reserved for communications with the one or more additional cells, a first set of sequences reserved for communications with the one or more additional cells, or both.

Aspect 7: The method of any of aspects 1 through 6, wherein communicating the plurality of access procedure messages further comprises: transmitting at least a portion of the plurality of access procedure messages on the one or more additional cells, wherein the UE indicates the selected at least one cell via the portion of the plurality of access procedure messages.

Aspect 8: The method of aspect 7, wherein communicating the plurality of access procedure messages further comprises: receiving at least a second portion of the plurality of access procedure messages on the selected at least one cell, wherein the selected at least one cell is different from the one or more additional cells.

Aspect 9: The method of any of aspects 1 through 8, wherein the UE transmits a plurality of first access procedure messages on a respective plurality of additional cells, the method further comprising: receiving a second access procedure message, wherein the second access procedure message indicates a second cell from the plurality of additional cells that received at least one of the plurality of first access procedure messages.

Aspect 10: The method of any of aspects 1 through 9, wherein communicating the plurality of access procedure messages further comprises: transmitting a first instance of a first access procedure message of the plurality of access procedure messages on at least one of the one or more additional cells; and monitoring for a second access procedure message for an access procedure duration based at least in part on transmitting the first access procedure message.

Aspect 11: The method of aspect 10, wherein communicating the plurality of access procedure messages further comprises: transmitting a second instance of the first access procedure message of the plurality of access procedure messages on the at least one or more additional cells based at least in part on the monitoring, wherein the second instance of the first access procedure message is associated with a higher transmission power than the first instance of the first access procedure message.

Aspect 12: The method of any of aspects 10 through 11, wherein communicating the plurality of access procedure messages further comprises: selecting one or more second cells from the first cell and the one or more additional cells for communicating the plurality of access procedure messages based at least in part on the monitoring; and transmitting a second instance of the first access procedure message of the plurality of access procedure messages on the one or more second cells.

Aspect 13: The method of aspect 12, wherein the UE selects the one or more second cells based at least in part on monitoring a threshold quantity of access procedure durations.

Aspect 14: The method of any of aspects 1 through 13, wherein communicating the plurality of access procedure messages further comprises: transmitting one or more first access procedure messages of the plurality of access procedure messages on the first cell; monitoring for a second access procedure message for a quantity of access procedure durations based at least in part on transmitting the one or more first access procedure messages; selecting the one or more additional cells for communicating the plurality of access procedure messages based at least in part on the monitoring; and transmitting the one or more first access procedure messages of the plurality of access procedure messages on the one or more additional cells.

Aspect 15: The method of any of aspects 1 through 14, wherein the UE selects the at least one cell based at least in part on a capability of the UE, the capability comprising a quantity associated with the one or more additional cells, an indication of whether an access procedure message can be transmitted on the first cell or the one or more additional cells, a quantity of repetitions associated with the first cell, the one or more additional cells, or both, an indication of whether repetitions of the plurality of access procedure messages can be communicated via a plurality of the one or more additional cells, band information associated with the one or more additional cells, or any combination thereof.

Aspect 16: The method of any of aspects 1 through 15, wherein the control information comprises: one or more ARFCN associated with the first cell, the one or more additional cells, or both, an indication of a configuration for an SSB associated with the first cell, the one or more additional cells, or both, a PCID associated with the first cell, the one or more additional cells, or both, selection criteria associated with the first cell, the one or more additional cells, or both, repetition information associated with the first cell, the one or more additional cells, or both, an indication of an association between an access procedure message and the first cell, the one or more additional cells, or both, SIB acquisition information associated with the first cell, the one or more additional cells, or both, an indication of a configuration for an access procedure duration associated with the first cell, the one or more additional cells, or both, transmission power information associated with the first cell, the one or more additional cells, or both, or any combination thereof.

Aspect 17: The method of any of aspects 1 through 16, wherein the control information is received on the first cell, the one or more additional cells, or both based at least in part on whether the first cell is a self-contained assisted cell.

Aspect 18: The method of any of aspects 1 through 17, wherein the control information is received on the first cell, the one or more additional cells, or both based at least in part on whether the UE selects the at least one cell based at least in part on a network command or selects the at least one cell based at least in part on performing measurements.

Aspect 19: A UE for wireless communications, comprising one or more memories storing processor-executable code, and one or more processors coupled with the one or more memories and individually or collectively operable to execute the code to cause the UE to perform a method of any of aspects 1 through 18.

Aspect 20: A UE for wireless communications, comprising at least one means for performing a method of any of aspects 1 through 18.

Aspect 21: A non-transitory computer-readable medium storing code for wireless communications, the code comprising instructions executable by one or more processors to perform a method of any of aspects 1 through 18.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, on a first cell, at least a portion of control information for communicating a plurality of access procedure messages on the first cell, one or more additional cells, or both;
select at least one cell from the first cell, the one or more additional cells, or both for communicating the plurality of access procedure messages; and
communicate the plurality of access procedure messages on the first cell, the one or more additional cells, or both, based at least in part on the selecting.

2. The UE of claim 1, wherein the one or more processors are individually or collectively further operable to execute the code to cause the UE to:
perform one or more measurements on the first cell, the one or more additional cells, or both based at least in part on the control information, wherein the UE selects the at least one cell based at least in part on the one or more measurements.

3. The UE of claim 1, wherein the UE selects the at least one cell based at least in part on the control information, the control information indicating for the UE to communicate the plurality of access procedure messages over the at least one cell.

4. The UE of claim 1, wherein the one or more processors are individually or collectively further operable to execute the code to cause the UE to:
receive a second portion of the control information on the first cell.

5. The UE of claim 1, wherein the one or more processors are individually or collectively further operable to execute the code to cause the UE to:
receive at least a second portion of the control information on the one or more additional cells.

6. The UE of claim 1, wherein, to communicate the plurality of access procedure messages, the one or more processors are individually or collectively further operable to execute the code to cause the UE to:
transmit a first access procedure message of the plurality of access procedure messages on the one or more additional cells, wherein the UE transmits the first access procedure message via a first set of resource occasions reserved for communications with the one or more additional cells, a first set of sequences reserved for communications with the one or more additional cells, or both.

7. The UE of claim 1, wherein, to communicate the plurality of access procedure messages, the one or more processors are individually or collectively further operable to execute the code to cause the UE to:
transmit at least a portion of the plurality of access procedure messages on the one or more additional cells, wherein the UE indicates the selected at least one cell via the portion of the plurality of access procedure messages.

8. The UE of claim 7, wherein, to communicate the plurality of access procedure messages, the one or more processors are individually or collectively further operable to execute the code to cause the UE to:
receive at least a second portion of the plurality of access procedure messages on the selected at least one cell, wherein the selected at least one cell is different from the one or more additional cells.

9. The UE of claim 1, wherein the UE transmits a plurality of first access procedure messages on a respective plurality of additional cells, and the one or more processors are individually or collectively further operable to execute the code to cause the UE to:
receive a second access procedure message, wherein the second access procedure message indicates a second cell from the plurality of additional cells that received at least one of the plurality of first access procedure messages.

10. The UE of claim 1, wherein, to communicate the plurality of access procedure messages, the one or more processors are individually or collectively further operable to execute the code to cause the UE to:
transmit a first instance of a first access procedure message of the plurality of access procedure messages on at least one of the one or more additional cells; and
monitor for a second access procedure message for an access procedure duration based at least in part on transmitting the first access procedure message.

11. The UE of claim 10, wherein, to communicate the plurality of access procedure messages, the one or more processors are individually or collectively further operable to execute the code to cause the UE to:
transmit a second instance of the first access procedure message of the plurality of access procedure messages on the at least one or more additional cells based at least in part on the monitoring, wherein the second instance of the first access procedure message is associated with a higher transmission power than the first instance of the first access procedure message.

12. The UE of claim 10, wherein, to communicate the plurality of access procedure messages, the one or more processors are individually or collectively further operable to execute the code to cause the UE to:
select one or more second cells from the first cell and the one or more additional cells for communicating the plurality of access procedure messages based at least in part on the monitoring; and
transmit a second instance of the first access procedure message of the plurality of access procedure messages on the one or more second cells.

13. The UE of claim 12, wherein the UE selects the one or more second cells based at least in part on monitoring a threshold quantity of access procedure durations.

14. The UE of claim 1, wherein, to communicate the plurality of access procedure messages, the one or more processors are individually or collectively further operable to execute the code to cause the UE to:
transmit one or more first access procedure messages of the plurality of access procedure messages on the first cell;
monitor for a second access procedure message for a quantity of access procedure durations based at least in part on transmitting the one or more first access procedure messages;
select the one or more additional cells for communicating the plurality of access procedure messages based at least in part on the monitoring; and
transmit the one or more first access procedure messages of the plurality of access procedure messages on the one or more additional cells.

15. The UE of claim 1, wherein the UE selects the at least one cell based at least in part on a capability of the UE, the capability comprising: a quantity associated with the one or more additional cells, an indication of whether an access procedure message can be transmitted on the first cell or the one or more additional cells, a quantity of repetitions associated with the first cell, the one or more additional cells, or both, an indication of whether repetitions of the plurality of access procedure messages can be communicated via a plurality of the one or more additional cells, band information associated with the one or more additional cells, or any combination thereof.

16. The UE of claim 1, wherein the control information comprises: one or more absolute radio-frequency channel numbers associate with the first cell, the one or more additional cells, or both, an indication of a configuration for a synchronization signal block associated with the first cell, the one or more additional cells, or both, a physical-layer cell identifier associated with the first cell, the one or more additional cells, or both, selection criteria associated with the first cell, the one or more additional cells, or both, repetition information associated with the first cell, the one or more additional cells, or both, an indication of an association between an access procedure message and the first cell, the one or more additional cells, or both, system information block acquisition information associated with the first cell, the one or more additional cells, or both, an indication of a configuration for an access procedure duration associated with the first cell, the one or more additional cells, or both, transmission power information associated with the first cell, the one or more additional cells, or both, or any combination thereof.

17. The UE of claim 1, wherein the control information is received on the first cell, the one or more additional cells, or both based at least in part on whether the first cell is a self-contained assisted cell.

18. The UE of claim 1, wherein the control information is received on the first cell, the one or more additional cells, or both based at least in part on whether the UE selects the at least one cell based at least in part on a network command or selects the at least one cell based at least in part on performing measurements.

19. A method for wireless communications at a user equipment (UE), comprising:
receiving, on a first cell, at least a portion of control information for communicating a plurality of access procedure messages on the first cell, one or more additional cells, or both;
selecting at least one cell from the first cell, the one or more additional cells, or both for communicating the plurality of access procedure messages; and
communicating the plurality of access procedure messages on the first cell, the one or more additional cells, or both, based at least in part on the selecting.

20. A non-transitory computer-readable medium storing code for wireless communications, the code comprising instructions executable by one or more processors to:
receive, on a first cell, at least a portion of control information for communicating a plurality of access procedure messages on the first cell, one or more additional cells, or both;
select at least one cell from the first cell, the one or more additional cells, or both for communicating the plurality of access procedure messages; and
communicate the plurality of access procedure messages on the first cell, the one or more additional cells, or both, based at least in part on the selecting.
